(19) United States
(12) Patent Application Publication
(10) Pub. No.: US 2023/0095351 A1
(43) Pub. Date: Mar. 30, 2023

(54) OFFLINE META REINFORCEMENT LEARNING FOR ONLINE ADAPTATION FOR ROBOTIC CONTROL TASKS

(71) Applicant: Intrinsic Innovation LLC, Mountain View, CA (US)

(72) Inventors: Jianlan Luo, Mountain View, CA (US); Stefan Schaal, Mountain View, CA (US); Sergey Vladimir Levine, Berkeley, CA (US); Zihao Zhao, Stanford, CA (US)

(21) Appl. No.: 17/945,871

(22) Filed: Sep. 15, 2022

Related U.S. Application Data
(60) Provisional application No. 63/244,668, filed on Sep. 15, 2021.

(51) Int. Cl. G06N 20/00

(52) U.S. Cl. CPC G06N 20/00

(57) ABSTRACT

Methods, systems, and apparatus, including computer programs encoded on computer storage media, for training a robotic control policy to perform a particular task. One of the methods includes performing a meta reinforcement learning phase including using training data collected for a plurality of different robotic control tasks and updating a robotic control policy according to the training data, wherein the robotic control policy is conditioned on an encoder network that is trained to predict which task is being performed from a context of a robotic operating environment; and performing an adaptation phase using a plurality of demonstrations for the particular task, including iteratively updating the encoder network after processing each demonstration of the plurality of demonstrations, thereby training the encoder network to learn environmental features of successful task runs.

### CROSS-REFERENCE TO RELATED APPLICATIONS

This application claims priority to U.S. Provisional Application No. 63/244,668, filed on Sep. 15, 2021. The disclosure of the prior application is considered part of and is incorporated by reference in the disclosure of this application.

### FIELD OF INVENTION

This invention relates to robotics, and more particularly to robotic control using reinforcement learning.

### BACKGROUND

This specification relates to robotic control using reinforcement learning.

In a reinforcement learning system, an agent interacts with an environment by performing actions that are selected by the reinforcement learning system in response to receiving observations that characterize the current state of the environment.

Some reinforcement learning systems select the action to be performed by the agent in response to receiving a given observation in accordance with an output of a neural network.

Neural networks are machine learning models that employ one or more layers of nonlinear units to predict an output for a received input. Some neural networks are deep neural networks that include one or more hidden layers in addition to an output layer. The output of each hidden layer is used as input to the next layer in the network, i.e., the next hidden layer or the output layer. Each layer of the network generates an output from a received input in accordance with current values of a respective set of parameters.

To adapt an already trained robotic control system to perform a new task that is different from the training task on which it has been trained, conventional reinforcement learning systems require lengthy (and correspondingly, costly) online meta-training phases. In addition, this online adaptation can and usually will fail to effectively generalize to new tasks that are too different from the training task. This can pose a significant challenge in many industrial applications where high success rates are critical.

### SUMMARY

This specification describes a system implemented as computer programs on one or more computers in one or more locations that implements and trains a neural network-based robotic control system that can select actions to be performed by a robot. The techniques described in this specification allow a system to leverage control policy experience from a variety of different tasks, which can be related tasks. For example, the system can use a number of different connector insertion tasks.

To adapt and fine-tune the control policy for a particular task, the control policy can be informed through by an encoder network that is configured to predict the task being performed from the environment context, e.g., from sensor data.

The system can first perform offline meta-learning for the plurality of different, but possibly related, tasks. The system can then perform task-specific adaptation using demonstrations for one particular task, which may but need not necessarily be one of the tasks used during the offline meta-learning phase. During the adaptation phase, the encoder network is continually updated to learn the attributes of successful demonstrations. During the adaptation phase, the control policy can be updated after each demonstration is processed. This means that the adaptation phase can be online in the sense that the next demonstration task will be processed using the updated control policy, as opposed to the offline meta-learning phase in which the same policy might be used for generating all updates. In both phases, however, the system need not actually interact with the robotic environment.

Finally, in an optional third, fine-tuning phase, the control policy can be continually updated in an online fashion with new trials in the operating environment.

The subject matter described in this specification can be implemented in particular embodiments so as to realize one or more of the following advantages.

This techniques disclosed in this specification can allow for a robotic control system to make effective use of the offline training data collected for a range of different tasks while being able to achieve faster online adaptation to any of a variety of new tasks. In particular, the techniques include a novel constraint that is being enforced implicitly (i.e., rather than explicitly) on the policy improvement step during the offline training to avoid bootstrapping errors resulting from out-of-distribution sampled actions which hinder successful learning of the action selection neural network. The techniques also include the use of context variables that represent task-specific context information on which the action selection outputs are conditioned, thereby facilitating structured and efficient exploration of the environment by the robot when the system is being trained on a new task.

As such, the disclosed techniques allow for training data from a replay memory to be utilized in a way that increases the value of the selected data during offline RL training, while additionally facilitating an effective action selection policy to be learned online with much greater sample efficiency for new tasks on which the system may not have been trained during the offline RL training. In other words, the amount of computing resources necessary for the training of the action selection neural networks across a range of different tasks can be reduced. For example, the amount of memory required for storing the training data can be reduced, the amount of processing resources used by the training process can be reduced, or both. The increased speed of training of action selection neural networks can be especially significant for complex neural networks that are harder to train or for training neural networks to select actions to be performed by robots performing complex reinforcement learning tasks.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example reinforcement learning system.

FIG. 2 is a flow diagram of an example process for training an action selection neural network.

FIG. 3A is an example illustration of training an action selection neural network.

FIG. 3B is an example illustration of meta-adaptation of a trained action selection neural network.

FIG. 3C is an example illustration of online fine-tuning of a trained selection neural network.

FIG. 4 is a flow diagram of an example process for meta-adaptation and online fine-tuning of a trained action selection neural network.

Like reference numbers and designations in the various drawings indicate like elements.

### DETAILED DESCRIPTION

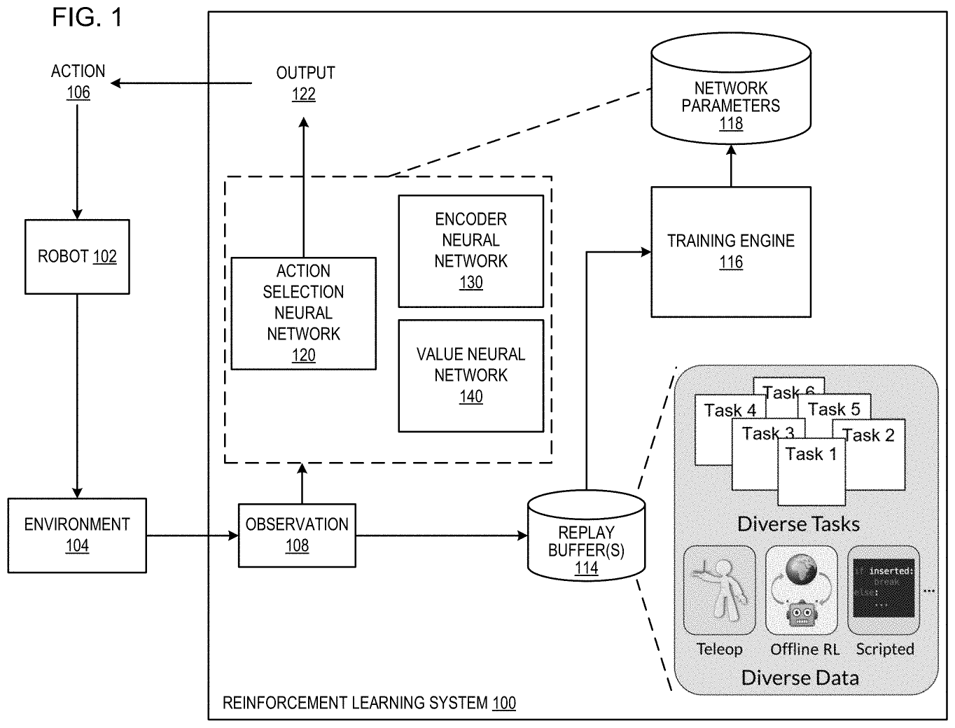

FIG. 1 shows an example reinforcement learning system 100. The reinforcement learning system 100 is an example of a system implemented as computer programs on one or more computers in one or more locations that controls a robot 102 (or another mechanical agent, e.g., an autonomous or semi-autonomous vehicle) interacting with an environment 104 by, at each of multiple time steps, processing data characterizing the current state of the environment at the time step (i.e., an “observation”) 108 to select an action 106 to be performed by the robot 102 in order to cause the robot to perform a particular task.

The tasks can for example include causing the robot 102 to navigate to different locations in the environment 104, causing the robot to locate different objects, causing the robot to pick up different objects or to move different objects to one or more specified locations, and so on. For example, the task can be include connector insertion tasks which require the robot 102 to insert different types of wire connectors into different types of sockets. As another example, in the cases where the robot 102 is a dexterous robot manipulator, e.g., a robotic hand or arm, the tasks can include dexterous manipulation tasks, including a valve rotation task, an object repositioning task, and a drawer opening task, and so on.

The reinforcement learning system 100 controls the robot by selecting actions 102 to be performed by the robot while the robot is interacting with the environment 104 in response to observations 108 that characterize states of the environment. The robot 102 typically moves (e.g. navigates and/or changes its configuration) within the environment 104.

The observations 108 may include, e.g., one or more of: images (such as ones captured by a camera and/or Lidar sensor), object position data, and other sensor data from sensors that capture observations as the robot interacts with the environment, for example sensor data from an image, distance, or position sensor or from an actuator. For example in the case of an articulated robot, the observations may include data characterizing the current state of the robot, e.g., one or more of: joint position, joint velocity, joint force, torque or acceleration, e.g., gravity-compensated torque feedback, and global or relative pose of an item held by the robot. In other words, the observations may similarly include one or more of the position, linear or angular velocity, force, torque or acceleration, and global or relative pose of one or more parts of the robot. The observations may be defined in 1, 2 or 3 dimensions, and may be absolute and/or relative observations. The observations may also include, for example, sensed electronic signals such as motor current or a temperature signal; and/or image or video data for example from a camera or a LIDAR sensor, e.g., data from sensors of the robot or data from sensors that are located separately from the robot in the environment.

The actions 106 may be control inputs to control the robot, e.g., torques for the joints of the robot or higher-level control commands, or the autonomous or semi-autonomous land, air, sea vehicle, e.g., torques to the control surface or other control elements of the vehicle or higher-level control commands.

In other words, the actions can include for example, position, velocity, or force/torque/acceleration data for one or more joints of a robot or parts of another mechanical agent. Action data may additionally or alternatively include electronic control data such as motor control data, or more generally data for controlling one or more electronic devices within the environment the control of which has an effect on the observed state of the environment.

In particular, the reinforcement learning system 100 selects actions 106 to be performed by the robot using an action selection neural network 120 and a training engine 116. The exact configuration of the action selection neural network 120 will be described further below, but in short, it can receive an input including an observation 108 about the state of the environment 104 and generate an action selection output 122 that can be used to determine an action 106 to be performed by the robot 102 at each of multiple time steps. To cause the robot to perform the determined action, the system 100 can for example pass a control signal to a robotic control system for the robot.

A few examples of the action selection output 122 are described next.

In one example, the action selection output 122 may include a respective numerical probability value for each action in a set of possible actions that can be performed by the robot. If being used to control the robot, the system 100 could select the action to be performed by the robot, e.g., by sampling an action in accordance with the probability values for the actions, or by selecting the action with the highest probability value.

In another example, the action selection output 122 may directly define the action to be performed by the robot, e.g., by defining the values of torques that should be applied to the joints of the robot.

In another example, the action selection output 122 may include a respective Q value for each action in the set of possible actions that can be performed by the robot. If being used to directly control the robot, the system 100 could process the Q values (e.g., using a soft-max function) to generate a respective probability value for each possible action, which can be used to select the action to be performed by the robot (as described earlier). The system 100 could also select the action with the highest Q value as the action to be performed by the robot.

The Q value for an action is an estimate of a “return” that would result from the robot performing the action in response to the current observation 108 and thereafter selecting future actions performed by the robot 102 in accordance with current values of the action selection network parameters.

A return refers to a cumulative measure of “rewards” received by the robot, for example, a time-discounted sum of rewards. The robot can receive a respective reward at each time step, where the reward is specified by a scalar numerical value and characterizes, e.g., a progress of the robot towards completing an assigned task.

To allow the robot 102 to effectively perform a particular robotic control task, the training engine 116 can use meta-reinforcement learning techniques to train the action selection neural network 120 by repeatedly selecting experience transitions (or “transitions” for short) from one or more replay buffers 114 and training the action selection neural network 120 on the selected transitions.

In particular, the training engine 116 trains the action selection neural network 120 together with an encoder neural network 130 and a value neural network 140 using an offline reinforcement learning technique, e.g., an advantage-weighted actor-critic reinforcement learning technique, broadly across multiple distinct robotic control tasks the experience transitions for which are currently available or otherwise easily obtainable.

The reinforcement learning system 100 maintains a set of network parameters 118 for the neural networks that are being trained, including parameters of the action neural network 120 (“action selection network parameters”), parameters of the encoder neural network 130 (“encoder network parameters”), and parameters of the value neural network 140 (“value network parameters”).

The reinforcement learning system 100 maintains, for each of the multiple distinct robotic control tasks, e.g., “tasks 1-6” in the example of FIG. 1, a plurality of transitions generated as a consequence of the interaction of the robot (or another robot) with the environment (or with another instance of the environment) for use in training the action selection neural network. The system 100 can store transitions for different tasks at one single replay buffer, or store transitions for different tasks across different replay buffers.

The system also maintains (in the same replay buffer or in a separate storage component) context information of each of the multiple distinct robotic control tasks. The context information is encapsulated in one or more context variables.

The action selection neural network 120 and the value neural network 140 are both configured to generate network outputs, i.e., action selection outputs and predicted Q values, respectively, conditioned on this task-specific context information. To generate the context information that is specific to a particular task, the reinforcement learning system 100 uses the encoder neural network 130 to determine respective values for one or more context variables that represent this context information and that will be processed by the action selection neural network 120 and the value neural network 140.

In more detail, the encoder neural network 130 can be configured to receive an encoder network input that includes a transition, data derived from the transition, or both and to process the encoder network input in accordance with current values of the encoder network parameters to generate a predicted distribution over a set of possible values for each of the one or more context variables. For each context variable, the value of the context variable can then be determined by performing sampling within the corresponding predicted distribution of possible values, or can alternatively be determined by performing sampling within a combined predicted distribution formed from respective predicted distributions generated by using the encoder neural network 130 to process multiple transitions for the same task.

The action selection neural network 120 can be configured to receive an action selection network input that includes (i) the current observation included in a selected transition and (ii) the one or more context variables and, in some cases, (iii) data specifying each action in a set of possible actions that can be performed by the robot, and to process the action selection network input in accordance with current values of the action selection network parameters to generate the action selection output.

The value neural network 140 can be configured to receive a value network input that includes (i) the current observation included in the selected transition, (ii) the current action performed by the robot in response to the current observation, and (iii) the one or more context variables and to process the value network input in accordance with current values of the value network parameters to generate a predicted Q value that is an estimate of a return that would be received by the robot by selecting actions using the action selection outputs starting from the current state characterized by the current observation included in the selected transition.

The action selection neural network 120, the encoder neural network 130, and the value neural network 140 can be implemented with any appropriate neural network architectures that enable them to perform their described functions. As a particular example, the neural networks 120, 130, and 140 can each be a respective fully-connected neural network, i.e., that includes one or more fully-connected neural network layers.

In some implementations, the reinforcement learning system 100 also maintains (in the same replay buffer or some other storage component) a plurality of demonstration transitions generated as a consequence of control of a robot by a demonstrator, possibly a remote demonstrator through teleoperation (“teleop”). While in some of these implementations, the demonstrator may be a human expert or another, already trained machine learning system on a robotic control task, which may be different from the multiple distinct tasks, in others of these implementations, the demonstrator may instead be an amateur demonstrator that generates suboptimal demonstration transitions, or a demonstrator adopting a fixed policy, e.g., a random policy that selects actions at random or another fixed policy that always selects actions according to programmed logic (“scripted”).

In an actor-critic RL training setup, the action selection neural network 120 may be referred to as the “actor” neural network because it is the neural network having parameter values that define an action selection policy used to select actions to be performed by the robot. The value neural network 140 may be referred to as the “critic” neural network because it is a neural network that is used to provide, for a particular action (e.g., an action selected using an action selection output of the actor selection neural network 120), an output which defines a predicted Q value representing the value of particular action in a current state of the environment. As described above, the Q value for an action is an estimate of a “return” that would result from the robot performing the action in response to the current observation and thereafter selecting future actions performed by the robot in accordance with current values of the action selection network parameters.

Once the neural networks has been trained, the reinforcement learning system 100 can provide data specifying the trained neural networks, e.g., data specifying the architecture of the action selection neural network 120 and the trained values of the action selection network parameters 118 to another system, e.g., a robotic control system. For example, once trained, the action selection neural network 120 can be used as part of the robotic control system to control a robot, i.e., to select actions to be performed by the robot while the robot is interacting with an environment, in order to cause the robot to perform a particular task. As another example, the system 100 can use the trained neural networks to process new observations 108 and generate action selection outputs 122 that can be used to control the robot 102 to perform the particular task.

Alternatively or in addition, in the cases where the particular task is different from any of the tasks, e.g., “tasks 1-6” in the example of FIG. 1, on which the neural networks have been trained, the reinforcement learning system 100 can use the training engine 116 to adapt the trained action selection neural network 120 to the particular task through (i) a meta-adaptation process which is based on orders of magnitude smaller data, e.g., demonstration transitions that are specific to the particular task, than training data used for the pre-training process, (ii) an online fine-tuning process which is based on relatively small number of online transitions generated as a consequence of actually controlling the robot to interact with the environment to perform the particular task, or both. That is, the reinforcement learning system 100 can efficiently and effectively adapt the broadly trained action selection neural network 120 to any of a variety of new tasks, even if they are distinct from the tasks on which the neural network has been trained. For example, the system or another robotic control system can then use the adapted neural network to control the robot to perform the particular task. As another example, the system can output data specifying the adapted neural network to the user that provided the demonstration transitions.

Here it is worthwhile to note that, by merit of the way the action selection neural network 120 has been trained, both the meta-adaptation process and the online fine-tuning process can be performed to adapt it to a new task with far less training data than was used to train the neural network. For example, while training the action selection neural network 120 may require hours of robot interaction with the environment for each individual task, adapting the neural network for a new task may require only a few minutes of expert demonstration of the new task.

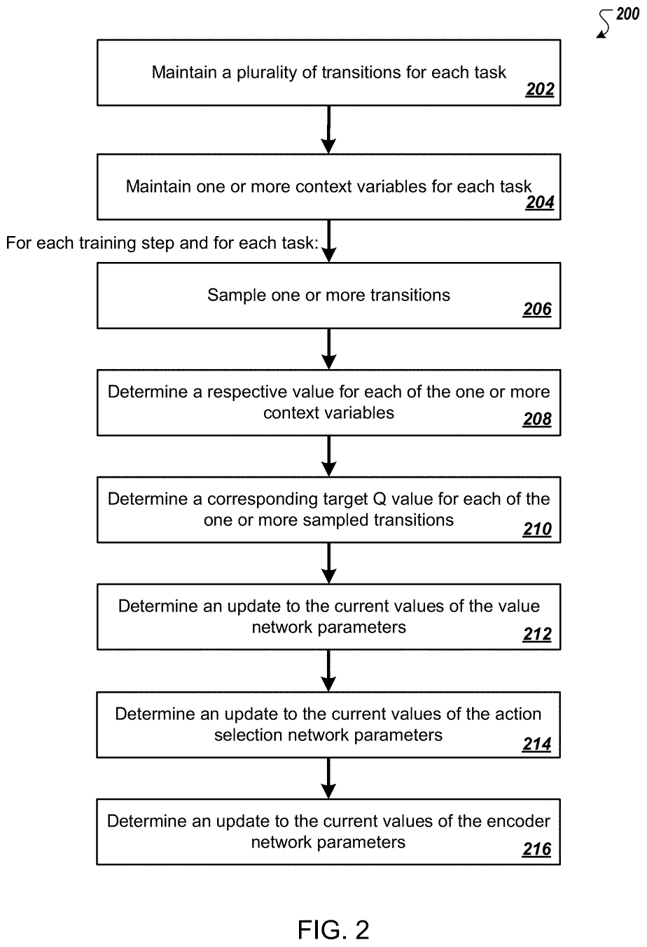

FIG. 2 is a flow chart of an example process 200 for training an action selection neural network. For convenience, the process 200 will be described as being performed by a system of one or more computers located in one or more locations. For example, a reinforcing learning system, e.g., the reinforcing learning system 100 of FIG. 1, appropriately programmed in accordance with this specification, can perform the process 200.

The system maintains, for each of a plurality of distinct robotic control tasks, a plurality of transitions generated as a result of controlling the robot to perform the task (step 202). Each transition represents information about an interaction of the robot with the environment while performing the task. Each transition can also represents information about a past experience of controlling the robot to perform the task.

In some implementations, each transition is an experience tuple that includes: (i) a current observation characterizing the current state of the environment at one time; (ii) a current action performed by the robot in response to the current observation; (iii) a next observation characterizing the next state of the environment after the robot performs the current action, i.e., a state that the environment transitioned into as a result of the robot performing the current action; (iv) a current reward received in response to the robot performing the current action; and, optionally, (v) a next action performed by the robot in response to the next observation.

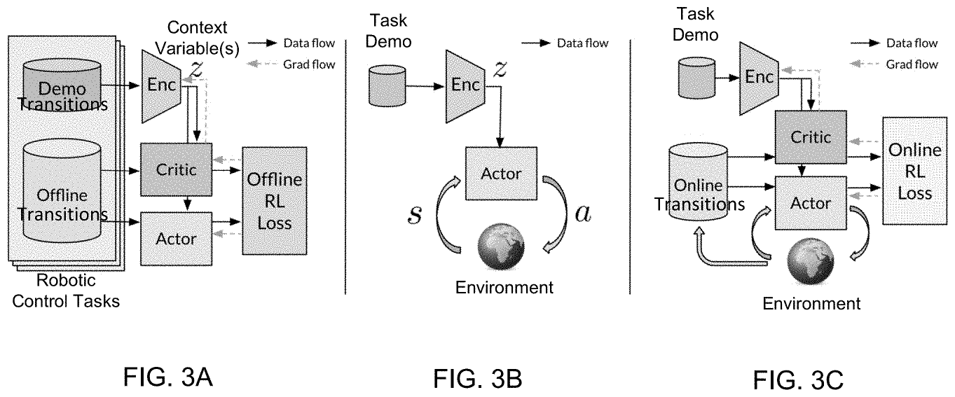

FIG. 3A is an example illustration of training an action selection neural network. In some implementations, as shown in FIG. 3A, the system also maintains a plurality of demonstration transitions generated as a consequence of control of the robot by a demonstrator.

The system maintains, for each of the plurality of distinct machine learning tasks, one or more context variables representing context information that is specific to the task (step 204).

The system repeatedly performs steps 206-216 to iterate through the plurality of distinct robotic control tasks (where each iteration of steps 206-216 may be referred to as one training step) to train the action selection neural network by iteratively updating the values of the action selection network parameters, until a termination criterion has been satisfied, e.g., until a threshold number of iterations have been performed, until a threshold amount of wall clock time has elapsed, or until the values of the action selection network parameters have converged.

The system samples one or more transitions from the plurality of transitions for the robotic control task (step 206). For example, the plurality of robotic control tasks may be ordered according to a predetermined order, and the system can begin with the first robotic control task in that order, then move to the next task, e.g., after a predetermined number of iterations of steps 206-216 have been performed, and so on until reaching the last task. For each robotic control task, the system will generally obtain different transitions at different iterations, e.g., by sampling a fixed number of transitions for the task from a replay buffer (e.g., the replay buffer(s) 114 of the reinforcement learning system 100 of FIG. 1) at each iteration with some degree of randomness.

The system determines a respective value for each of the one or more context variables for the robotic control task by using an encoder neural network having a plurality of encoder network parameters (step 208). The encoder neural network is configured to receive an encoder network input that includes a transition and to process the encoder network input in accordance with current values of the encoder network parameters to generate a predicted distribution over a set of possible values for each of the one or more context variables. The value for each context variable can then be determined by sampling a respective value in accordance with the predicted distribution. In other words, the system uses the encoder neural network to generate an output that, for each context variable, parameterizes a distribution, e.g., a Gaussian distribution, over a set of possible values for the context variable and samples a context variable from that distribution.

In some implementations, the transition can be one of the sampled transitions at the current training step while in other implementations, as shown in FIG. 3A, the transition can be a demonstration transition that is sampled from a plurality of demonstration transitions generated as a consequence of control of the robot by a demonstrator.

In some implementations, the context information is generated from multiple transitions for the task, and the system can use the encoder neural network to repeatedly process multiple transitions to generate, for each of the one or more context variables, a respective predicted distribution for each transition which are then combined to determine a combined predicted distribution, e.g., by computing a product of the respective predicted distributions. In these implementations, the value for each context variable can then be determined by sampling a respective value in accordance with the combined predicted distribution.

The system determines a corresponding learning target for each of the one or more sampled transitions by using a value neural network having a plurality of value network parameters (step 210). The learning target can include a combination of a target Q value generated for each of the one or more sampled transitions, and the value neural network is configured to receive a value network input that includes (i) the next observation included in the sampled transition, (ii) the next action included in the sampled transition, and (iii) the one or more context variables having the determined values, and to process the value network input in accordance with current values of the value network parameters to generate the target Q value that is an estimate of a return that would be received by the robot by performing the next action in response to the next state characterized by the next observation included in the sampled transition. As such, each target Q values generated by the value neural network is conditioned on determined values of the one or more context variables which represent context information specific to the task. The target Q values can then be combined, e.g., by computing a weighted or unweighted average, to provide the learning target for each sampled transition.

The system determines an update to the current values of the value network parameters (step 212) based on optimizing a value objective function that measures, for the each of the one or more sampled transitions, a difference between (i) a sum of the learning target and the current reward included in the sampled transition and (ii) a predicted Q value. In some implementations, the difference is a square difference. Specifically, the system determines a gradient of the value objective function with respect to the value network parameters and determines, from the gradient, the update to the current values of the value network parameters. For example, the system can determine the gradient through backpropagation, and then determine the update by applying an update rule to gradient, e.g., a stochastic gradient descent update rule, an Adam optimizer update rule, an rmsProp update rule, or the like.

The predicted Q value, which is an estimate of a return that would be received by the robot by selecting actions using the action selection outputs starting from the current state characterized by the current observation included in the sampled transition, is similarly generated by using the value neural network. In more detail, the value neural network is configured to receive a value network input that includes (i) the current observation included in the sampled transition, (ii) the current action performed by the robot in response to the current observation, and (iii) the one or more context variables having the determined values, and to process the value network input in accordance with current values of the value network parameters to generate the predicted Q value. In this way, the system trains the value neural network to generate, for each sampled transition, a predicted Q value that is close to the learning target.

The system determines an update to the current values of the action selection network parameters (step 214) based on optimizing an action selection objective function that includes a term dependent on an advantage value estimate for the current state characterized by the current observation included in each of the one or more sampled transitions. Specifically, the system determines a gradient of the action selection objective function with respect to the action selection network parameters and determines, from the gradient, the update to the current values of the action selection network parameters. For example, the system can determine the gradient through backpropagation, and then determine the update by applying an update rule to gradient, e.g., a stochastic gradient descent update rule, an Adam optimizer update rule, an rmsProp update rule, or the like.

The action selection objective function enables the action selection neural network to generate the action selection outputs that result in actions being selected that improve an estimate of a return that would be received if the robot performed the selected actions in response to the current observation, while constraining the selected actions to stay close to the current actions included in the sampled transitions, i.e., encouraging the action selection neural network to generate action selection outputs from which actions similar to those included in the sampled transitions will be determined.

In some implementations, the action selection objective function is of the form

$$log ( π ) exp ( \frac{1}{λ} A ) ,$$

where π is action selection output, A is the advantage value estimate, and λ tunable temperature hyperparameter.

The advantage value estimate for the current state characterized by the current observation can be computed as a difference between (i) the predicted Q value for the current state that is generated by using the value neural network from processing the value network input and (ii) a predicted state value for the current state that is an estimate of a return resulting from the environment being in the current state. The predicted state value for the current state, which may also be referred to as a baseline value for the current state, represents the expected return from current state when following the action selection policy defined by the current values of the action selection network parameters.

The system determines an update to the current values of the encoder network parameters (step 216) based on optimizing an encoder objective function that measures at least a difference between the predicted distribution generated by the encoder neural network and a predetermined distribution for each of the one or more context variables. In some implementations, the encoder objective function also measures, for the each of the one or more sampled transitions, the difference between the learning target and the predicted Q value, which can be computed in a similar manner as in step 212 described above. Specifically, the system determines a gradient of the encoder objective function with respect to the encoder network parameters and determines, from the gradient, the update to the current values of the encoder network parameters. For example, the system can determine the gradient through backpropagation, and then determine the update by applying an update rule to gradient, e.g., a stochastic gradient descent update rule, an Adam optimizer update rule, an rmsProp update rule, or the like.

In some implementations, the predetermined distribution is a unit Gaussian distribution [symbol] (0, l), and the difference between the predicted distribution and the predetermined distribution is computed as a Kullback-Leibler (KL) divergence. The encoder objective function constrains mutual information between the context information represented by the one or more context variables and information contained in the one or more sampled transitions.

In this way, the system trains the encoder neural network by using a variational approximation to an information bottleneck that constrains the mutual information between the sampled transitions and the one or more context variables. Intuitively, this bottleneck constrains the one or more context variables to contain only information from the context that is necessary to adapt to a particular task, mitigating overfitting to the training tasks.

An example algorithm for training an action selection neural network is shown below.

Algorithm 1 ODA Meta-training

```
Require: D_{demo}ⁱ and D_{offline}ⁱ for each of N training tasks,
    learning rates η₁, η₂, η₃, temperature λ, KL weight β
  1: Init. encoder q_{ϕ}, actor π_{θ}, critic Q_{ψ}
  2: while not converged do
  3:  for task i = 1, 2, . . . , N do
  4:  Sample demo data as context cᵢ~D_{demo}ⁱ
  5:  Sample offline data (s, a, s′, a′, r)~D_{offline}ⁱ
  6:  Sample task variable zᵢ~q_{ϕ}(·|cᵢ)
  7:  y = r(s, a) + γ [symbol]  _{s′, a′~D}_{_{offline}}_{ⁱ} Q_{ψ}(s′, a′, zᵢ)
  8: [symbol]   _{critic}ⁱ(Q_{ψ} (s, a, zᵢ) − y)²
  9:   ${ℒ}_{actor}^{i} = - log {π}_{θ} ( a \vert s , {z}_{i} ) exp ( \frac{1}{λ} {A}^{π} ( s , a , {z}_{i} ) )$
10: [symbol]   _{KL}ⁱ = βD_{KL} (q_{ϕ}(·|cᵢ)| [symbol]   (0, I))
11:  end for
12:  ϕ ← ϕ − η₁ ∇_{ϕ} Σᵢ( [symbol]  _{critic}ⁱ + [symbol]  _{KL}ⁱ)
13:  θ ← θ − η₂ ∇_{θ} Σᵢ [symbol] _{actor}ⁱ
14:  ψ ← ψ − η₃ ∇_{ψ} Σᵢ [symbol] _{critic}ⁱ
15: end while
```

In the example algorithm shown above, q_{ϕ} denotes the encoder network parameters of the encoder neural network, π_{θ} denotes the action selection network parameters of the action selection neural network (the “actor” neural network, and Q_{ψ} denotes the value network parameters of the value neural network (the “critic” neural network).

In some implementations, after obtaining the trained action selection neural network by performing the process 200, the system can proceed to adapt the trained network to a particular task which may be different from any of the distinct robotic control tasks on which the network has been trained.

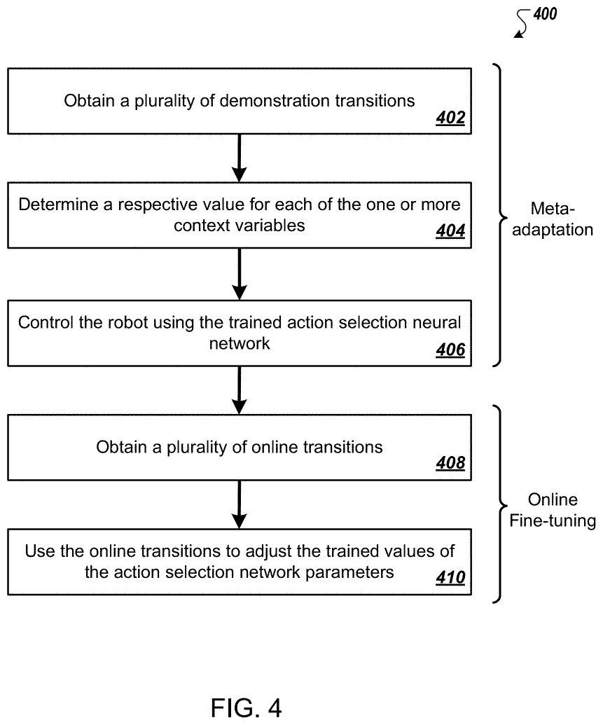

FIG. 4 is a flow diagram of an example process 400 for meta-adaptation and online fine-tuning of a trained action selection neural network. For convenience, the process 400 will be described as being performed by a system of one or more computers located in one or more locations. For example, a reinforcing learning system, e.g., the reinforcing learning system 100 of FIG. 1, appropriately programmed in accordance with this specification, can perform the process 400.

FIG. 3B is an example illustration of meta-adaptation of a trained action selection neural network to a particular robotic control task. The meta-adaptation process generally involves determining new values for the one or more context variables by using demonstration tasks of the particular task. The one or more context variables will be processed by the trained action selection neural network to adapt it to the particular task. Generally, the new values for the one or more context variables will be different from the values for those learned during the training process.

The system obtains a plurality of demonstration transitions generated as a consequence of controlling, by a demonstrator in the particular robotic control task, a robot to interact with the environment to perform the particular robotic control task (step 402). For example, the demonstrator may be a human expert or another, already trained machine learning system on the particular robotic control task.

The system determines a respective value for each of the one or more context variables for the particular robotic control task (step 404). Specifically, for each obtained demonstration transition, the encoder neural network is configured to process an encoder network input that includes the demonstration transition in accordance with the trained values of the encoder network parameters to generate an output from which the respective value for each of the one or more context variables can be determined, i.e., through sampling within the one or more distributions parameterized by the output.

The system controls the robot using the trained action selection neural network, conditioned on the one or more context variables having the determined values, to interact with the environment to perform the particular task (step 406). At each of multiple time steps during the interaction with the environment, the action selection neural network is configured to receive an action selection network input that includes (i) a current observation characterizing a state of the environment at the current time step and (ii) the one or more context variables and, in some cases, (iii) data specifying each action in a set of possible actions that can be performed by the robot, and to process the action selection network input in accordance with the trained values of the action selection network parameters to generate the action selection output, which can then be used to determine an action to be performed by the robot at the current time step.

FIG. 3C is an example illustration of online fine-tuning of a trained selection neural network to a particular robotic control task. The online fine-tuning process can be performed subsequent to the meta-adaptation process in cases where meta-adaptation alone cannot successfully adapt the action selection neural network to the particular robotic control task, i.e., in cases where the meta-adapted action selection neural network obtained from performing steps 402-406 of process 400 is yet to generate action selection outputs that could be used to effectively control the robot to perform the particular task.

As part of the online fine-tuning process, the system obtains and uses online transitions for the particular task to fine-tune the trained values of the action selection network parameters. In other words, unlike the meta-adaptation process, the online fine-tuning process additionally learns new values for the network parameters.

The system obtains a plurality of online transitions (step 408) that are generated as a consequence of actually controlling the robot using the trained neural networks to interact with the environment to perform the particular task, as described above with reference to step 406.

The system uses the plurality of demonstration transitions and the plurality of online transitions to adjust the trained values of the action selection network parameters (step 410) and, in some cases, the encoder network parameters and the value network parameters, too. The system can adjust these parameters in a similar manner to training the neural networks on offline transitions as described above with reference to steps 210-216 of FIG. 2.

An example algorithm for meta-adaptation and online fine-tuning of a trained action selection neural network is shown below.

Algorithm 2 ODA Adaptation and Finetuning

| Require: Test task demo Dₜₑₛₜ, learning rates η₁, η₂, η₃, | |
|---|---|
| | temperature λ, KL weight β, Pretrained π_{θ}, Q_{ψ}, q_{ϕ} |
| 1: | Init. empty online buffer [symbol] |
| 2: | Sample demo data as context c ~ Dₜₑₛₜ |
| 3: | Sample task variable z ~ q_{ϕ}(•\|c) |
| 4: | Evaluate policy π_{θ}(•\|s, z), exit if policy solves the task |
| 5: | while not converged do |
| 6: | collect trajectory τ by executing policy π_{θ}(•\|s, z) |
| 7: | add τ to [symbol] |
| 8: | Sample demo data as context c ~ Dₜₑₛₜ |
| 9: | Sample offline data (s, a, s′, r) ~ [symbol] |
| 10: | Sample task variable z ~ q_{ϕ}(•\|c) |
| 11: | Calculate [symbol] _{actor}, [symbol] _{critic}, [symbol] _{K L} same as Algo.1 |
| 12: | ϕ ← ϕ − η₁∇_{ϕ}( [symbol] _{critic} + [symbol] _{K L}) |
| 13: | θ ← θ − η₂∇_{θ} [symbol] _{actor} |
| 14: | ψ ← ψ − η₃∇_{ψ} [symbol] _{critic} |
| 15: | end while |

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method performed by one or more computers to train a robotic control policy to perform a particular task, the method comprising:
performing a meta reinforcement learning phase including using training data collected for a plurality of different robotic control tasks and updating a robotic control policy according to the training data,
wherein the robotic control policy is conditioned on an encoder network that is trained to predict which task is being performed from a context of a robotic operating environment; and
performing an adaptation phase using a plurality of demonstrations for the particular task, including iteratively updating the encoder network after processing each demonstration of the plurality of demonstrations, thereby training the encoder network to learn environmental features of successful task runs.

2. The method of claim 1, further comprising performing a fine-tuning phase for the particular task including continually updating the robotic control policy according to experience data gathered in the operating environment.

3. The method of claim 1, wherein the meta reinforcement learning phase comprises performing offline reinforcement learning.

4. The method of claim 1, wherein performing the meta reinforcement learning phase comprises:
maintaining, at one or more replay buffers and for each of a plurality of distinct robotic control tasks, a plurality of transitions that each represent a past experience of controlling the robot to perform the distinct robotic control task;
for each of multiple training steps and for each of the plurality of distinct robotic control tasks:
sampling one or more transitions from the plurality of transitions for the robotic control task;
determining, for each of the one or more sampled transitions, a corresponding learning target that is dependent on respective values of one or more context variables determined based on using an encoder neural network, wherein the one or more context variables represent context information that is specific to the task; and
determining an update to the current values of the action selection network parameters that enables the action selection neural network to generate the action selection outputs that result in actions being selected that improve the estimate of the return that would be received if the robot performed the selected actions in response to the current observation, while constraining the selected actions according to past experience represented by the sampled transitions.

5. The method of claim 4, wherein for each of the plurality of distinct robotic control tasks, each transition comprises: (i) a current observation characterizing a current state of the environment; (ii) a current action performed by the robot in response to the current observation; (iii) a next observation characterizing a next state of the environment after the robot performs the current action; and (iv) a current reward received in response to the robot performing the current action.

6. The method of claim 4, wherein sampling the one or more transitions from the plurality of transitions for the robotic control task comprises:
determining a respective value for each of the one or more context variables for the robotic control task, comprising processing an encoder network input that includes a sampled transition using the encoder neural network having a plurality of encoder network parameters and in accordance with current values of the encoder network parameters to generate a predicted distribution over a set of possible values for each of the one or more context variables.

7. The method of claim 4, wherein the learning target comprises a target Q value, and wherein determining the corresponding target Q value for each of the one or more sampled transitions comprises:
processing a value network input that includes (i) the next observation included in the transition and (ii) the one or more context variables having the respective determined values using a value neural network having a plurality of value network parameters and in accordance with current values of the value network parameters to generate a predicted Q value that is an estimate of a return that would be received by the robot starting from the next state characterized by the next observation included in the transition.

8. The method of claim 7, wherein the method further comprises, for each of multiple training steps and for each of the plurality of distinct robotic control tasks:
determining an update to the current values of the value network parameters based on optimizing a value objective function that measures, for the each of the one or more sampled transitions, a difference between the learning target and a predicted Q value, wherein the predicted Q value is generated by using the value neural network and in accordance with the current values of the value network parameters to process a value network input that includes (i) the current observation included in the transition and (ii) the one or more context variables having the respective determined values.

9. The method of claim 7, wherein determining the update to the current values of the action selection network parameters comprises:
determining the update based on optimizing an action selection objective function that includes a term dependent on an advantage value estimate for the current state characterized by the current observation included in each of the one or more sampled transitions.

10. The method of claim 4, wherein the method further comprises, for each of multiple training steps and for each of the plurality of distinct robotic control tasks:
determining, based on optimizing an encoder objective function that measures at least a difference between the predicted distribution generated by the encoder neural network and a predetermined distribution for each of the one or more context variables, an update to the current values of the encoder network parameters that constrains mutual information between the context information represented by the one or more context variables and information contained in the one or more sampled transitions.

11. The method of claim 4, wherein the action selection neural network is configured to process an action selection network input that includes (i) the current observation included in the sampled transition and (ii) the one or more context variables in accordance with current values of the action selection network parameters to generate the action selection output.

12. The method of claim 11, wherein the action selection network input also includes data specifying each action in a set of possible actions that can be performed by the robot.

13. The method of claim 4, wherein the action selection output includes a respective numerical probability value for each action in the set of possible actions that can be performed by the robot.

14. The method of claim 6, wherein determining the respective value for each of the one or more context variables for the robotic control task further comprises, for each of the one or more context variables:
determining a combined predicted distribution from the predicted distributions generated by using the encoder neural network from processing the encoder network inputs that each include a respective sampled transition.

15. The method of claim 14, wherein determining the combined predicted distribution comprises computing a product of the predicted distributions.

16. The method of claim 14, wherein determining the respective value for each of the one or more context variables for the robotic control task further comprises, for each of the one or more context variables:
sampling a respective value in accordance with the combined predicted distribution.

17. The method of claim 9, wherein the advantage value estimate for the current state characterized by the current observation is computed as a difference between (i) the predicted Q value for the current state that is generated by using the value neural network from processing the value network input and (ii) a predicted state value for the current state that is an estimate of a return resulting from the environment being in the current state.

18. The method of claim 7, wherein the value network input also includes data specifying a possible action that can be performed by the robot.

19. The method of claim 10, wherein the predetermined distribution is a unit Gaussian distribution.

20. The method of claim 10, wherein the encoder objective function also measures, for the each of the one or more sampled transitions, the difference between the target Q value and the predicted Q value.

21. The method of claim 1, wherein the action selection objective function is of the form log(π)exp(1/λA), where π is action selection output, A is the advantage value estimate, and λ a tunable hyperparameter.

22. The method of claim 1, wherein the difference between the predicted distribution and the predetermined distribution is computed as a Kullback-Leibler (KL) divergence.

23. The method of claim 1, further comprising causing the robot to perform the actions selected by using the action selection outputs.

24. The method of claim 1, wherein the encoder neural network and the action selection neural network are trained on different sampled transitions.

25. The method of claim 1, further comprising:
obtaining a plurality of demonstration transitions generated by a demonstrator in the particular robotic control task; and
using the plurality of demonstration transitions to adjust the current values of the action selection network parameters, comprising determining a respective value for each of the one or more context variables for the particular robotic control task based on using the encoder neural network to process an encoder network input that includes a demonstration transition in accordance with trained values of the encoder network parameters.

26. The method of claim 1, wherein the particular robotic control task is different from any of the plurality of distinct robotic control tasks.

27. The method of claim 1, wherein constraining the selected actions according to the current actions included in the sampled transitions comprises:
encouraging the selected actions to stay close to the current actions included in the sampled transitions.

28. The method of claim 1, wherein the particular robotic control task is a dexterous manipulation task.

29. The method of claim 25, wherein the dexterous manipulation task comprises one of:
a valve rotation task, an object repositioning task, or a drawer opening task performed by a robotic arm.

30. A system comprising one or more computers and one or more storage devices storing instructions that are operable, when executed by the one or more computers, to cause the one or more computers to perform operations to train a robotic control policy to perform a particular task, wherein the operations comprise:
performing a meta reinforcement learning phase including using training data collected for a plurality of different robotic control tasks and updating a robotic control policy according to the training data,
wherein the robotic control policy is conditioned on an encoder network that is trained to predict which task is being performed from a context of a robotic operating environment; and
performing an adaptation phase using a plurality of demonstrations for the particular task, including iteratively updating the encoder network after processing each demonstration of the plurality of demonstrations, thereby training the encoder network to learn environmental features of successful task runs.

31. A computer storage medium encoded with instructions that, when executed by one or more computers, cause the one or more computers to perform operations to train a robotic control policy to perform a particular task, wherein the operations comprise:
performing a meta reinforcement learning phase including using training data collected for a plurality of different robotic control tasks and updating a robotic control policy according to the training data,
wherein the robotic control policy is conditioned on an encoder network that is trained to predict which task is being performed from a context of a robotic operating environment; and
performing an adaptation phase using a plurality of demonstrations for the particular task, including iteratively updating the encoder network after processing each demonstration of the plurality of demonstrations, thereby training the encoder network to learn environmental features of successful task runs.
